(19) United States
(12) Patent Application Publication
(10) Pub. No.: US 2021/0130008 A1
(43) Pub. Date: May 6, 2021

(54) Towing Vehicle for Aircraft and Method for Towing an Aircraft

(71) Applicant: Axel Schickling, Visbek (DE)

(72) Inventor: Axel Schickling, Visbek (DE)

(21) Appl. No.: 16/674,541

(22) Filed: Nov. 5, 2019

(51) Int. Cl. B64F 1/22; B60B 19/00; B60D 1/42; B60D 1/48; B60P 3/11; G01S 17/06; G05D 1/02

(52) U.S. Cl. CPC B64F 1/227; B64F 1/228; B60B 19/00; G05D 1/0231; B60D 1/488; B60P 3/11; G01S 17/06; B60D 1/42

(57) ABSTRACT

A towing vehicle for aircraft and method for towing an aircraft. The towing vehicle has a chassis, running gear that carries the chassis, and drive, which drives the running gear for moving the chassis. A support wheel receiving device is mounted on the chassis so that it can rotate around a vertical compensation axis of rotation, in particular within a 360 degree rotational range, relative to the chassis. A rotary drive drives the support wheel receiving device. A sensor array with alignment sensors senses alignment of the aircraft relative to the alignment sensors. The towing vehicle has a digital control unit to regulate rotational position of the support wheel receiving device as a function of the sensed alignment of the aircraft relative to the alignment sensors by the rotary drive to keep alignment of the support wheel receiving device relative to the aircraft within a prescribed range.

### BACKGROUND OF THE INVENTION

### Field of the Invention

The invention relates to a towing vehicle for aircraft which has a three-point running gear with a main running gear and a support running gear with support wheel, in particular a nosewheel running gear with a main running gear and a nose running gear with nose wheel, with a chassis, with a running gear that carries the chassis for moving the chassis, with a drive with which the running gear can be driven for actively moving the chassis, with a support wheel receiving device for receiving the support wheel, which is mounted on the chassis so that it can be rotated around a vertical compensation axis of rotation, in particular within a 360 degree turning range, relative to the chassis, and with a rotary drive, which can be used to drive the support wheel receiving device for actively twisting the support wheel receiving device relative to the chassis. The invention also relates to a method for towing an aircraft which has a three-point running gear with a main running gear and a support running gear with support wheel, in particular a nosewheel running gear with a main running gear and a nose running gear with support wheel, with the use of a towing vehicle. An aircraft is here understood as both an airplane with nonrotating lifting surfaces and a rotorcraft, in particular such as a helicopter.

### Brief Description of Related Art

Such an aircraft has a three-point running gear with a main running gear and a support running gear with support wheel. As a rule, the three-point running gear is a nosewheel running gear, in which the support running gear is designed as a nosewheel running gear with a nosewheel. By contrast, if the three-point running gear is a tailwheel running gear, the support running gear is designed as a tailwheel running gear with a tailwheel as the support wheel.

Such a towing vehicle has a chassis and a running gear for moving the chassis. The running gear here carries the chassis. Such a towing vehicle further has a drive, with which the running gear can be driven for actively moving the chassis. In addition, such a towing vehicle is also provided with a support wheel receiving device for receiving the support wheel. The support wheel receiving device is mounted on the chassis, and can here be turned by 360 degrees relative to the chassis around a vertical compensation axis of rotation.

Such a towing vehicle is known from DE 102011010727 B4 of the applicant. In another further development of the towing vehicle disclosed therein that is likewise known but not yet mentioned in DE 102011010727 B4, it is further provided that the towing vehicle have a rotary drive, which can be used to drive the support wheel receiving device for actively twisting the support wheel receiving device relative to the chassis. As a result, once the towing vehicle has twisted relative to the aircraft, a counter-rotational movement of the support wheel receiving device can be initiated to ensure that the support wheel is once again aligned in the longitudinal direction of the aircraft. This makes it possible to prevent the support wheel from being twisted too far relative to the alignment of the aircraft.

However, in several aircraft types in which the support running gear can be turned around an axis of rotation that is not vertically aligned, the contact area of support wheel tires becomes entangled on the support wheel receiving device, thus placing a disadvantageous load on the support wheel and towing vehicle if the return of the support wheel alignment is not initiated in time by actively twisting the support wheel receiving device with the rotary drive. In extreme cases, the support wheel can become excessively twisted, and the support wheel can also be unilaterally overloaded, here potentially also causing damage to the support running gear.

### SUMMARY OF THE INVENTION

Therefore, the object of the invention is to further develop a towing vehicle of the kind mentioned at the outset in such a way as to lessen the danger of damage being done to the support wheel, in particular the nosewheel, and the danger of damage being done to the towing vehicle. Furthermore, a method for towing an aircraft is to be indicated.

The invention achieves this object with a towing vehicle for aircraft and a method for towing an aircraft according to the claims. Advantageous further developments of the invention are indicated in the subclaims.

In a towing vehicle for aircraft having a three-point running gear with a main running gear and a support running gear with support wheel, in particular a nose running gear with a main running gear and a nose running gear with nosewheel, with a chassis, with a running gear that carries the chassis for moving the chassis, with a drive with which the running gear can be driven for actively moving the chassis, with a support wheel receiving device for receiving the support wheel, which is mounted on the chassis so that it can be rotated around a vertical compensation axis of rotation, in particular within a 360 degree turning range, relative to the chassis, and with a rotary drive, which can be used to drive the support wheel receiving device for actively twisting the support wheel receiving device relative to the chassis, the invention provides that the towing vehicle have a sensor array with alignment sensors, with which the alignment of the aircraft relative to the alignment sensors can be sensed, and a digital control unit, which is set up to regulate the rotational position of the support wheel receiving device as a function of the sensed alignment of the aircraft relative to the alignment sensors by means of the rotary drive in such a way as to keep the alignment of the support wheel receiving device relative to the aircraft within a prescribed range.

In a method for towing an aircraft having a three-point running gear with a main running gear and a support running gear with support wheel, in particular a nosewheel running gear with a main running gear and a nose running gear with nosewheel, with the use of a towing vehicle, in particular the towing vehicle according to the invention, wherein a support wheel receiving device of the towing vehicle receives and carries the support wheel, wherein a drive of the towing vehicle drives a drives a running gear of the towing vehicle, and thereby moves a chassis of the towing vehicle carried by the running gear, on which the support wheel receiving device is mounted so that it can rotate around a vertical compensation axis of rotation relative to the chassis, and wherein a rotary drive of the towing vehicle drives the support wheel receiving device and twists it actively relative to the chassis, the invention provides that, while the running gear moves the chassis, the alignment sensors of a sensor array of the towing vehicle sense the alignment of the aircraft relative to the alignment sensors, and a digital control unit of the towing vehicle regulates the rotational position of the support wheel receiving device as a function of the sensed alignment of the aircraft relative to the alignment sensors by means of a rotary drive in such a way as to keep the alignment of the support wheel receiving device relative to the aircraft within a prescribed range.

In particular, the prescribed range is here smaller than the range within which the support wheel can be swiveled in a permissible manner relative to the alignment of the aircraft. For example, the prescribed range measures 40 degrees, meaning 20 degrees in each direction proceeding from an average alignment of the support wheel parallel to the central axis of the aircraft. The prescribed range preferably measures less than 30 degrees, or especially preferably less than 20 degrees. In particular, a swiveling by the nosewheel can be countered early on, since the control unit continuously readjusts the rotational position of the support wheel receiving device while the towing vehicle is moving.

The rotational position of the support wheel receiving device is here readjusted fully automatically as a function of data from the sensor array, which are transmitted to the control unit. The alignment sensors detect the alignment of the aircraft relative to the alignment sensors. If the alignment sensors are arranged directly on the support wheel receiving device, the control unit can detect the current rotational position of the support wheel receiving device relative to the aircraft directly from the data from the alignment sensors, since the support wheel receiving device with the alignment sensors and the support wheel are aligned in the same manner relative to the aircraft. By contrast, if the alignment sensors are arranged on the chassis of the towing vehicle, the alignment of the support wheel receiving device relative to the chassis must also be considered, so that the current alignment of the support wheel relative to the aircraft can be inferred from the data of the alignment sensors.

In an embodiment of the invention in which the alignment sensors are arranged on the chassis, it is thus further provided for sensing the alignment of the aircraft relative to the chassis that the sensor array have rotational angle sensors, which can be used to sense the rotational position of the support wheel receiving device relative to the chassis. It is here further provided that the control unit be designed to regulate the rotational position of the support wheel receiving device relative to the chassis as a function of the sensed alignment of the support wheel receiving device relative to the chassis in conjunction with the sensed rotational position of the support wheel receiving device relative to the chassis by means of the rotary drive in such a way as to keep the alignment of the support wheel receiving device relative to the aircraft within the prescribed range. In particular, the alignment sensors are here arranged offset to the vertical compensation axis of rotation of the support wheel receiving device on the chassis.

The control unit is here preferably designed to use the alignment of the aircraft relative to the chassis sensed by means of the alignment sensors and the alignment of the support wheel receiving device relative to the chassis determined by means of the rotational angle sensors to determine the alignment of the aircraft relative to the support wheel receiving device, and to regulate the rotational position of the nosewheel receiving device as a function of the determined alignment of the aircraft relative to the support wheel receiving device by means of the rotary drive in such a way as to keep the alignment of the support wheel receiving device relative to the aircraft within a prescribed range.

The control unit either subtracts errors caused by the alignment sensors being displaced from the compensation axis of rotation. Alternatively, the control unit ignores any errors associated with this displacement, and here determines a slightly erroneous alignment of the aircraft relative to the support wheel receiving device, wherein the rotational position of the support wheel receiving device is readjusted in a timely manner in such a way in each case as to keep the alignment of the support wheel receiving device relative to the aircraft within the prescribed range.

Alternatively, the alignment sensors are arranged on the nosewheel receiving device for sensing the alignment of the aircraft relative to the nosewheel receiving device. The rotational angle sensors for sensing the rotational position of the support wheel receiving device can possibly still be present, for example to reliably align the towing vehicle with its longitudinal direction, and hence parallel to the longitudinal axis in the main traveling direction, or to align the support wheel receiving device for approaching or leaving the support wheel in such a way as to align an opening in a rotating ring of the support wheel receiving device on one side of the chassis, with which the towing vehicle can laterally approach the support wheel or travel laterally away from the support wheel.

In an advantageous embodiment of the towing vehicle, the rotational angle sensors have an encoder, which can be used to sense revolutions, in particular of a drive shaft, on the rotary drive. The control unit in this embodiment is further preferably designed to determine the rotational position of the nosewheel receiving device from the sensed revolutions, in particular of the drive shaft. It would also be possible, but less advantageous, to alternatively sense the rotational position of the support wheel receiving device directly on the support wheel receiving device, or to provide a stepper motor, which eliminates the need for further sensing.

There are various ways to detect the alignment of the aircraft relative to the alignment sensors. In particular, various measuring principles are conceivable for this purpose. In an advantageous embodiment of the towing vehicle, the alignment sensors have at least one LIDAR, which in particular is arranged on the chassis of the aircraft. The LIDAR can be used to sense the environment of the alignment sensors, in particular within an angular range of at least 250 degrees or of about 270 degrees or of 360 degrees. The LIDAR provides the sensed data. In this embodiment, the control unit is preferably designed to determine the position of the main running gear of the aircraft relative to the alignment sensors from the data provided by the LIDAR, and to determine the alignment of the aircraft relative to the alignment sensors based upon the determined position of the main running gear. The main running gear usually has two supports in the area of the main running gear, which reflect light beams emitted by the LIDAR, and can thereby be detected in the data provided by the LIDAR with their angle at which they are aligned relative to the LIDAR and their distance from the LIDAR. Therefore, the control unit can use the detected position of these supports of the main running gear to infer the alignment of the aircraft relative to the LIDAR, and thus determine the alignment of the aircraft relative to the alignment sensors.

In an alternative embodiment of the towing vehicle, the alignment sensors have a first position sensor, which in particular is arranged on the support wheel receiving device. This first position sensor interacts with a second position sensor secured to the aircraft fuselage. In particular, the second position sensor is only secured to the aircraft temporarily for towing the aircraft and subsequently removed again. The position sensors interact in such a way as to sense the position of the position sensors relative to each other. The control unit is here designed to determine the alignment of the aircraft relative to the alignment sensors from this sensed position.

In an advantageous embodiment of the invention, the support wheel receiving device can be manually twisted if desired. To this end, the control unit at least temporarily stops regulating the rotational position of the support wheel receiving device. In particular, the process of sensing the alignment of the aircraft relative to the sensor array and a rotational movement of the rotary drive are suspended for this purpose. In addition, the control unit preferably actuates the rotary drive or support wheel receiving device in such a way as to decouple the support wheel receiving device from the rotary drive. The support wheel receiving device can then be manually twisted relative to the chassis, in particular freely by 360 degrees. The desire to manually twist the support wheel receiving device is transmitted to the control unit in particular in the form of a request signal, for example from a remote controller. Conversely, the automatic regulation of the rotary position of the support wheel receiving device can be reactivated once again if desired, for example likewise by transmitting a corresponding request signal to the control unit, and the rotary drive can if necessary be recoupled with the support wheel receiving device for this purpose.

The running gear of the towing vehicle preferably has two load-bearing vehicle wheels, which can be turned around a shared horizontal wheel axis that is fixed relative to the chassis for actively moving the chassis, and driven by the drive either together or individually. It is preferably further provided that these vehicle wheels for turning the towing vehicle around a vertical axis of vehicle rotation that intersects the horizontal wheel axis between the vehicle wheels can be driven in an opposite rotational direction at the same or also at a differing speed. The vertical compensation axis of rotation and vertical vehicle axis of rotation are here preferably spaced apart from each other by less than half the distance that the load-bearing vehicle wheels are spaced apart from each other. As a consequence, the load of the aircraft supported by the support wheel lies on the towing vehicle in the area of the wheel axis, and is thus predominantly diverted via the load-bearing vehicle wheels on the wheel axis.

An advantageous embodiment of the towing vehicle provides that the running gear have at least one, preferably precisely one, freely rotatable, supporting vehicle wheel, and that the vertical compensation axis of rotation be arranged between the horizontal wheel axis and the at least one supporting vehicle wheel. This ensures that the towing vehicle will always stand securely on all at least three vehicle wheels of the towing vehicle, even while exposed to the load of the support wheel of the aircraft. Simultaneously arranging the vertical compensation axis of rotation in proximity to the horizontal axis of rotation also ensures that the load resting on the at least one supporting vehicle wheel is comparatively slight relative to the load resting on the load-bearing vehicle wheels on the wheel axis, and that at least one supporting vehicle wheel can thus turn freely without any pivot bearings required for this purpose being exposed to an excessive load.

As an alternative to designing the towing vehicle with a supporting vehicle wheel, it would also be conceivable to design the towing vehicle with chains instead of the vehicle wheels on the wheel axis.

### BRIEF DESCRIPTION OF THE DRAWINGS

Additional embodiments may be gleaned from the claims, the drawings and the following description of an especially preferred exemplary embodiment of the invention shown in the drawings. The drawings show:

FIG. 1: A top view of selected outlines of an aircraft and a towing vehicle towing the aircraft according to a preferred exemplary embodiment of the invention;

FIG. 2: A schematic, boxed view showing the structural design of the towing vehicle in the exemplary embodiment on FIG. 1; and

FIG. 3: A perspective view of the towing vehicle in the exemplary embodiment on FIGS. 1 and 2.

### DETAILED. DESCRIPTION OF THE PREFERRED EMBODIMENTS

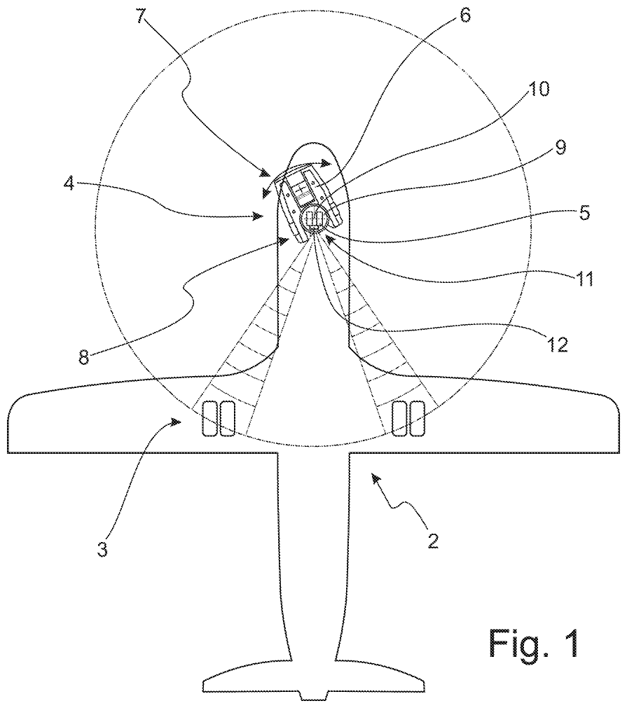

FIG. 1 shows selected outlines of an aircraft 1, which has a three-point running gear 2 designed as a nosewheel running gear, with a main running gear 3 and a support running gear 4 in the form of a nosewheel running gear. The main running gear 3 has wheels, each with several tires under load-bearing surfaces of the aircraft 1. The support running gear 4 has a support wheel 5 in the form of a nosewheel with two tires.

Further shown on FIG. 1 is an especially preferred embodiment of a towing vehicle 6 according to the invention. The towing vehicle 6 has a chassis 7, which is supported on a running gear 8. A support wheel receiving device 9 is further mounted on the chassis 7 so that it can rotate around a vertical alignment axis of rotation 10 relative to the chassis 7. The support wheel 5 is received by the support wheel receiving device 9, and thus lifted relative to a subsurface, on which both the aircraft 1 with its main running gear 3 and the towing vehicle 6 stand. For this reason, the towing vehicle 6, which is actively driven for this purpose, can move the aircraft 1, e.g., meaning out of a hangar and onto a runway or conversely from a runway into a hangar. The towing vehicle 6 can here turn around the support wheel 5 that remains fixed or nearly fixed in place in the tightest of spaces. To this end, the towing vehicle 6 can turn at the location of the main running gear 3. This makes the towing vehicle 6 very maneuverable. Therefore, the nose of the aircraft 1 can be moved to within only a very small safety distance of a wall or corner of the hangar so as to economize on space.

Even during rotations of the towing vehicle 6 relative to the aircraft 1, the towing vehicle 6 according to the invention is designed to leave the support wheel 5 aligned parallel to the longitudinal axis of the aircraft 1 or at least limit a swiveling by the support wheel 5 relative to the longitudinal axis of the aircraft 1. This counteracts any entanglement of the tires of the support wheel 5 and an excessive swiveling of the support wheel 5 in the support wheel receiving device 9, and also prevents the support running gear 4 from being screwed in beyond a maximum permissible angle. To this end, the towing vehicle 6 has a rotary drive for actively twisting the support wheel receiving device 9 relative to the chassis 7. The towing vehicle 6 further has a sensor array 11 with alignment sensors 12. The alignment sensors 12 are arranged on the support wheel receiving device 9, and sense the position of the main running gear 3 relative to the alignment sensors 12.

The towing vehicle 6 further has a digital control unit, which not only controls a movement by the towing vehicle 6, for example guided by means of a remote controller, but is also designed to regulate the rotational position of the support wheel receiving device 9 as a function of the sensed alignment of the aircraft 1 relative to the alignment sensors 12 by means of the rotary drive in such a way as to keep the alignment of the support wheel receiving device 9 relative to the aircraft 1 within a prescribed range. In particular, the digital control unit thus ensures that the support wheel receiving device 9 keeps the support wheel 5 aligned at least roughly parallel to the longitudinal axis of the aircraft 1.

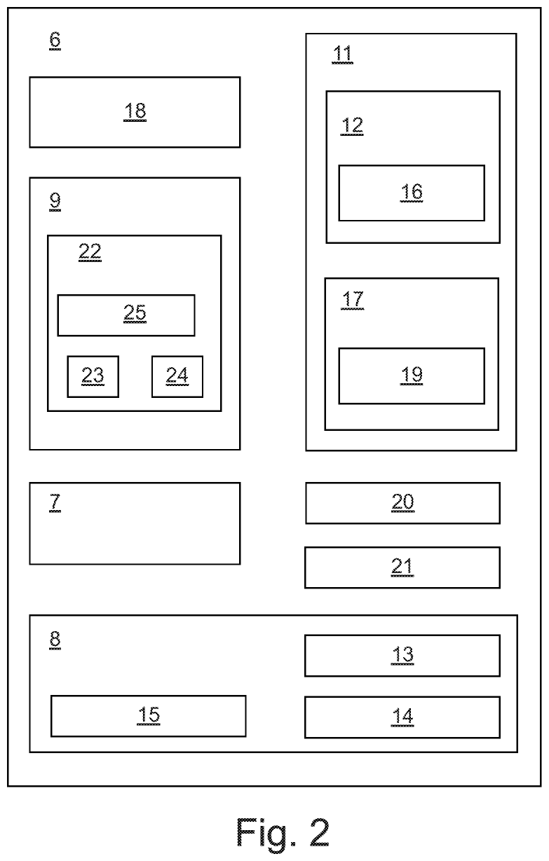

FIG. 2 shows a schematic structural design of the towing vehicle 6 on FIG. 1. The same reference numbers denote identical parts on all figures.

The running gear 8 of the towing vehicle 6 is designed similarly to the three-point running gear 2 of the aircraft 1, and has a first load-bearing vehicle wheel 13, a second load-bearing vehicle wheel 14 and a supporting vehicle wheel 15. In alternative exemplary embodiments, at least one additional supporting vehicle wheel can also be provided.

In particular, the alignment sensors 12 have a LIDAR 16 or comprise a LIDAR 16. In an alternative to the exemplary embodiment shown, the alignment sensors 12 alternatively or additionally have a position sensor, which interacts with another position sensor on the aircraft 1. The sensor array 11 also has rotational angle sensors 17, by means of which the already mentioned digital control unit here denoted for the first time with reference number 18 can determine the rotational angle of the support wheel receiving device 9 relative to the chassis 7. To this end, the rotational angle sensors 17 in particular have an encoder 19, which preferably is secured directly to the also already mentioned rotational drive 20 for the support wheel receiving device 9 denoted here for the first time. In particular, the rotary drive 20 is designed as a DC electric motor, wherein the encoder 19 is integrated directly in the rotary drive 20. The rotary drive 20 is arranged on the chassis 7, and is actuated by the digital control unit 18. The digital control unit 18 also actuates a drive 21 for the load-bearing vehicle wheels 13 and 14.

In particular, the rotary drive 20 drives a slewing ring 22 of the support wheel receiving device. The slewing ring 22 has a first adjustable support shell 23 and a second adjustable support shell 24 for lifting and clamping the support wheel 5 in place. The slewing ring 22 further has a ring section 25 to be opened laterally, which can be swiveled to open the slewing ring 22, so that the towing vehicle 6 can laterally approach the support wheel, and the slewing ring 22 can be closed again once the support wheel 5 is located in the area of the support shells 23 and 24.

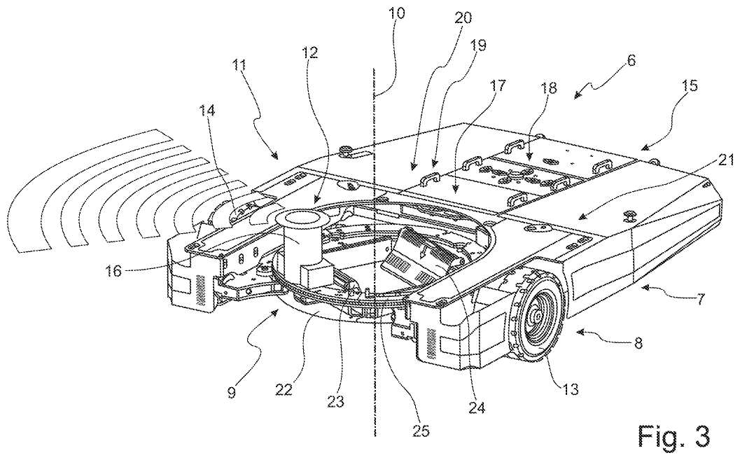

FIG. 3 shows a perspective view of the towing vehicle 6 in conjunction with an illustration of an essentially horizontal scanning of the environment by means of the LIDAR 16. In the exemplary embodiment shown, the LIDAR 16 is fastened directly to the stewing ring 22 of the support wheel receiving device 9, but as an alternative to the depicted exemplary embodiment can also be arranged on the chassis 7. The digital control unit 18, rotary drive 20 and drive 21 are concealed behind panels of the chassis 7, and thus not directly visible in the illustration according to FIG. 3.

The load of the support running gear 4 of the aircraft 1 is applied predominantly to the load-bearing vehicle wheels 13 and 14. Therefore, the load-bearing vehicle wheels 13 and 14 are advantageously also suitable for driving the towing vehicle 6, wherein the load-bearing vehicle wheels 13 and 14 can be driven independently and even in the opposite rotational direction right away for the towing vehicle 6 to negotiate curves or the towing vehicle 6 to be turned. For this purpose, the supporting vehicle wheel 15 is freely rotatably arranged, so that the supporting vehicle wheel 15 automatically swivels in a suitable manner given a change in the ratio between the rotational speeds of the load-bearing vehicle wheels 13 and 14.

Thanks to the invention, the digital control unit 18 can always keep the towing vehicle 6 aligned optimally relative to the aircraft 1 by actuating the rotary drive 20 as a function of data from the sensor array 11 during all traveling maneuvers of the towing vehicle 6, so that entanglements of the support wheel 5 in the support shells 23 and 24 do not take place even given an inclinedly arranged support running gear 4 of the aircraft 1, and the support running gear 4 is prevented from excessively twisting. This all takes place completely automatically while the towing vehicle 6 is traveling, so that the towing vehicle 6 need not be stopped for this purpose, and the aircraft 1 can be quickly maneuvered with the towing vehicle 6.

All features mentioned in the above specification and in the claims can be combined as desired with the features in the independent claims. The disclosure of the invention is thus not limited to the described and/or claimed feature combinations; rather, all sensible feature combinations within the framework of the invention must be regarded as disclosed.

1. A towing vehicle for aircraft, which has a three-point running gear with a main running gear and a support running gear with support wheel, in particular a nosewheel running gear with a main running gear and a nose running gear with nose wheel, with a chassis, with a running gear that carries the chassis for moving the chassis, with a drive with which the running gear can be driven for actively moving the chassis, with a support wheel receiving device for receiving the support wheel, which is mounted on the chassis so that it can be rotated around a vertical compensation axis of rotation, in particular within a 360 degree turning range, relative to the chassis, and with a rotary drive, which can be used to drive the support wheel receiving device for actively twisting the support wheel receiving device relative to the chassis, wherein
the towing vehicle has a sensor array with alignment sensors, with which the alignment of the aircraft relative to the alignment sensors can be sensed, and a digital control unit, which is set up to regulate the rotational position of the support wheel receiving device as a function of the sensed alignment of the aircraft relative to the alignment sensors by means of the rotary drive in such a way as to keep the alignment of the support wheel receiving device relative to the aircraft within a prescribed range.

2. The towing vehicle according to claim 1, characterized in wherein the alignment sensors are arranged on the chassis for sensing the alignment of the aircraft relative to the chassis, that the sensor array has rotational angle sensors, which can be used to sense the rotational position of the support wheel receiving device relative to the chassis, and that the control unit is designed to regulate the rotational position of the support wheel receiving device relative to the chassis as a function of the sensed alignment of the support wheel receiving device relative to the chassis in conjunction with the sensed rotational position of the support wheel receiving device relative to the chassis by means of the rotary drive in such a way as to keep the alignment of the support wheel receiving device relative to the aircraft within the prescribed range.

3. The towing vehicle according to claim 2, wherein the alignment sensors are here arranged offset to the vertical compensation axis of rotation of the support wheel receiving device on the chassis, and that the control unit is designed to use the alignment of the aircraft relative to the chassis sensed by means of the alignment sensors and the alignment of the support wheel receiving device relative to the chassis determined by means of the rotational angle sensors to determine the alignment of the aircraft relative to the support wheel receiving device, and to regulate the rotational position of the support wheel receiving device as a function of the determined alignment of the aircraft relative to the support wheel receiving device by means of the rotary drive in such a way as to keep the alignment of the support wheel receiving device relative to the aircraft within a prescribed range.

4. The towing vehicle according to claim 1, wherein the alignment sensors are arranged on the support wheel receiving device for sensing the alignment of the aircraft relative to the support wheel receiving device.

5. The towing vehicle according to claim 2, wherein the rotational angle sensors have an encoder, which can be used to sense revolutions, in particular of a drive shaft, on the rotary drive, and that the control unit is designed to determine the rotational position of the support wheel receiving device from the sensed revolutions, in particular of the drive shaft.

6. The towing vehicle according to claim 1, wherein the alignment sensors have a LIDAR, in particular on the chassis, which can be used to sense the environment, in particular within an angular range of at least 250 degrees or of about 270 degrees or of 360 degrees, and to provide the sensed data, and that the control unit is designed to determine the position of the main running gear of the aircraft relative to the alignment sensors from the data provided by the LIDAR, and to determine the alignment of the aircraft relative to the alignment sensors based upon the determined position of the main running gear.

7. The towing vehicle according to claim 1, wherein the alignment sensors have a first position sensor, in particular on the support wheel receiving device, which interacts with a second position sensor secured to the aircraft fuselage, in order to sense the position of the position sensors relative to each other, and that the control unit is designed to determine the alignment of the aircraft relative to the alignment sensors from this sensed position.

8. The towing vehicle according to claim 1, wherein the control unit is designed, in particular in response to a request signal for manually twisting the support wheel receiving device, to at least temporarily end the process of regulating the rotational position of the support wheel receiving device, and actuate the rotary drive or support wheel receiving device in such a way as to decouple the support wheel receiving device from the rotary drive, after which the support wheel receiving device can be twisted relative to the chassis around the vertical compensation axis of rotation.

9. The towing vehicle according to claim 1, wherein the running gear has two load-bearing vehicle wheels, which can be turned around a shared horizontal wheel axis that is fixed relative to the chassis for actively moving the chassis, and driven by the drive, that these load-bearing vehicle wheels for turning the towing vehicle around a vertical axis of vehicle rotation that intersects the horizontal wheel axis between the load-bearing vehicle wheels can be driven in an opposite rotational direction, and that the vertical compensation axis of rotation and vertical vehicle axis of rotation are spaced apart from each other by less than half the distance that the load-bearing vehicle wheels are spaced apart from each other.

10. The towing vehicle according to claim 9, wherein the running gear has at least one freely rotatable supporting vehicle wheel, and that the vertical compensation axis of rotation is arranged between the horizontal wheel axis and the supporting vehicle wheel.

11. A method for towing an aircraft, which has a three-point running gear with a main running gear and a support running gear with support wheel, in particular a nosewheel running gear with a main running gear and a nose running gear with support wheel, with the use of a towing vehicle, in particular according to claim 1, wherein a support wheel receiving device of the towing vehicle receives and carries the support wheel, wherein a drive of the towing vehicle drives a running gear of the towing vehicle, and thereby moves a chassis of the towing vehicle carried by the running gear, on which the support wheel receiving device is mounted so that it can rotate around a vertical compensation axis of rotation, in particular within a 360 degree turning range, relative to the chassis, and wherein a rotary drive of the towing vehicle drives the support wheel receiving device and twists it actively relative to the chassis, wherein, while the running gear moves the chassis, alignment sensors of a sensor array of the towing vehicle sense the alignment of the aircraft relative to the alignment sensors, and a digital control unit of the towing vehicle regulates the rotational position of the support wheel receiving device as a function of the sensed alignment of the aircraft relative to the alignment sensors by means of the rotary drive in such a way as to keep the alignment of the support wheel receiving device relative to the aircraft within a prescribed range.

12. The method according to claim 11, wherein the alignment sensors are arranged on the chassis and sense the alignment of the aircraft relative to the chassis, that rotational angle sensors of the sensor array sense the rotational position of the support wheel receiving device relative to the chassis, and that the control unit regulates the rotational position of the support wheel receiving device relative to the chassis as a function of the sensed alignment of the support wheel receiving device relative to the chassis in conjunction with the sensed rotational position of the support wheel receiving device relative to the chassis by means of the rotary drive in such a way as to keep the alignment of the support wheel receiving device relative to the aircraft within the prescribed range.

13. The method according to claim 12, wherein the alignment sensors are arranged offset to the vertical alignment axis of rotation of the support wheel receiving device on the chassis, and that the control unit determines the alignment of the aircraft relative to the support wheel receiving device from the alignment of the aircraft relative to the chassis sensed by means of the alignment sensors and the alignment of the support wheel receiving device relative to the chassis determined by means of the rotational angle sensors, and regulates the rotational position of the support wheel receiving device as a function of the determined alignment relative to the support wheel receiving device by means of the rotary drive in such a way as to keep the alignment of the support wheel receiving device relative to the aircraft within the prescribed range.

14. The method according to claim 11, wherein the alignment sensors are arranged on the support wheel receiving device, and sense the alignment of the aircraft relative to the support wheel receiving device.

15. The method according to claim 11, wherein an encoder of the rotational angle sensors senses revolutions, in particular of a drive shaft, on the rotary drive, and that the control unit determines the rotational position of the support wheel receiving device from the sensed revolutions, in particular of the drive shaft.

16. The method according to claim 11, wherein a LIDAR of the alignment sensors, in particular arranged on the chassis, senses the environment, in particular within an angular range of at least 250 degrees or of about 270 degrees or of 360 degrees, and provides sensed data, and that the control unit determines the position of the main running gear of the aircraft relative to the alignment sensors from the data provided by the LIDAR, and determines the alignment of the aircraft relative to the alignment sensors based upon the determined position of the main running gear.

17. The method according to claim 11, wherein a first position sensor, in particular arranged on the support wheel receiving device, interacts with a second position sensor secured to the aircraft fuselage, in order to sense the position of the position sensors relative to each other, and that the control unit determines the alignment of the aircraft relative to the alignment sensors from this sensed position.

18. The method according to claim 11, wherein the control unit, in particular in response to a request signal for manually twisting the support wheel receiving device, at least temporarily ends the process of regulating the rotational position of the support wheel receiving device, and actuates the rotary drive or support wheel receiving device in such a way as to decouple the support wheel receiving device from the rotary drive, after which the support wheel receiving device can be twisted relative to the chassis around the vertical compensation axis of rotation.

19. The method according to claim 11, wherein two load-bearing vehicle wheels of the running gear turn around a shared horizontal wheel axis that is fixed relative to the chassis for actively moving the chassis, and are driven by the drive, that these load-bearing vehicle wheels for turning the towing vehicle around a vertical axis of vehicle rotation that intersects the horizontal wheel axis between the load-bearing vehicle wheels are driven in an opposite rotational direction, and that the vertical compensation axis of rotation and vertical vehicle axis of rotation are spaced apart from each other by less than half the distance that the load-bearing vehicle wheels are spaced apart from each other.

20. The method according to claim 19, wherein the running gear has at least one freely rotatable supporting vehicle wheel, and that the vertical compensation axis of rotation is arranged between the horizontal wheel axis and the supporting vehicle wheel.
